(19) United States
(12) Patent Application Publication
(10) Pub. No.: US 2007/0014249 A1
(43) Pub. Date: Jan. 18, 2007

(54) Logical connection method in network and information processor

(75) Inventor: Satoshi Deishi, Ibaraki-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/482,578

(22) Filed: Jul. 7, 2006

(30) Foreign Application Priority Data
Jul. 13, 2005 (JP) JP2005-204746

(51) Int. Cl. H04L 12/28; H04L 12/56

(52) U.S. Cl. 370/254; 370/395.3

(57) ABSTRACT

A logical connection method in a network in which plural terminals are connected for intercommunication is provided. The method includes letting each of the terminals store a connection management table and plural connection tables, the connection management table indicating other end of a logical connection at present, and each of the connection tables indicating other end of a logical connection corresponding to each of various types of logical networks that are determined in advance, transmitting a table switching command that designates any of the connection tables from at least one of the terminals to other terminal, in response to reception of the table switching command, letting each of the terminals switch contents of the connection management table to contents of the connection table designated by the received table switching command.

This application is based on Japanese Patent Application No. 2005-204746 filed on Jul. 13, 2005, the contents of which are hereby incorporated by reference.

### BACKGROUND OF THE INVENTION

1. Field of the Invention

The present invention relates to a logical connection in a network.

2. Description of the Related Art

Peer-to-peer (hereinafter referred to as P2P) systems are widely used in LANs within companies or at homes because they require no dedicated server machines and they can be established at a relatively low cost. The P2P systems capable of transferring even large files efficiently are suitable network configurations, especially in intranets that aim at sharing information dispersedly stored in many OA machines.

Attention has recently been focused on the P2P technology in which information is directly exchanged among individuals in the general public on the Internet. There has been an increase in research on large-scale networks on the premise of a connection of an unspecified number of terminals.

For example, Japanese unexamined patent publication No. 2005-115453 proposes that nodes similar to one another in users' preference are relocated in a self-organizing manner to be close to one another on a network. Stated differently, the publication proposes that a logical connection among terminals is changed to suit users' preference. Such self-organization of the network can reduce traffic and can improve the probability of discovering contents.

In a physical network on the premise of the use by specified users, such as an intranet, there is a demand that the users wish to properly use the network to fit each application depending on business circumstances. For example, the proper use of the network includes the following: 1. Terminals are used for ordinary business during office hours, while many terminals are used for one large computation out of office hours. 2. The network is usually used for ordinary business, while the network is used as a communication tree by which information is promptly conveyed to all the terminals only at a specified time such as in the event of an emergency.

In order to use the physical network properly, it is necessary to promptly change a logical connection among terminals, i.e., to promptly establish a logical network suitable for an application.

Conventional methods and systems, however, could not meet such requests. The self-organization of the network described above is for gradually optimizing a logical connection based on the past communication records and not for instantaneously changing a logical connection over the entire network fundamentally.

### SUMMARY OF THE INVENTION

The present invention is directed to solve the problems pointed out above, and therefore, an object of the present invention is to achieve a switch from a logical connection suitable for an application to a logical connection suitable for another application.

A first logical connection method achieving the object of the present invention is a logical connection method in a network in which plural terminals are connected in a manner to communicate with one another. The method includes letting each of the terminals store a connection management table and plural connection tables, the connection management table indicating other end of a logical connection at present, and each of the connection tables indicating other end of a logical connection corresponding to each of various types of logical networks that are determined in advance, transmitting a table switching command that designates any of the connection tables from at least one of the terminals to the terminal that is the other end of the logical connection indicated in the connection management table stored in the terminal, in response to reception of the table switching command, transmitting the received table switching command from each of the terminals to the terminal that is the other end of the logical connection indicated in the connection management table, and letting each of the terminals switch contents of the connection management table to contents of the connection table designated by the received table switching command.

A second logical connection method is a logical connection method in a network in which plural terminals are connected in a manner to communicate with one another. The method includes letting each of the terminals store a connection management table indicating other end of a logical connection at present, letting at least one of the terminals store plural connection tables each of which indicates other end of a logical connection corresponding to each of various types of logical networks that are determined in advance, transmitting a table switching command including any one of the connection tables from the terminal storing the connection tables to the terminal that is the other end of the logical connection indicated in the connection management table stored in the terminal storing the connection tables, in response to reception of the table switching command, transmitting the received table switching command from at least the terminal other than the terminal storing the connection tables to the terminal that is the other end of the logical connection indicated in the connection management table, and letting at least the terminal other than the terminal storing the connection tables switch contents of the connection management table to contents of the connection table included in the received table switching command.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of a network configuration according to the present invention.

FIG. 2 is a diagram showing a functional configuration of the main section of a node in a first embodiment.

FIGS. 3A-3C show plural logical networks.

FIGS. 4A-4D show examples of contents of connection tables respectively stored in nodes.

FIG. 5 is a flowchart of processing of switching connections executed by a command processing portion according to the first embodiment.

FIG. 6 shows another example of a logical network.

FIG. 7 is a diagram showing a functional configuration of the main section of a node in a second embodiment.

FIG. 8 is a flowchart of processing of switching connections executed by a command processing portion according to the second embodiment.

### DESCRIPTION OF THE PREFERRED EMBODIMENTS

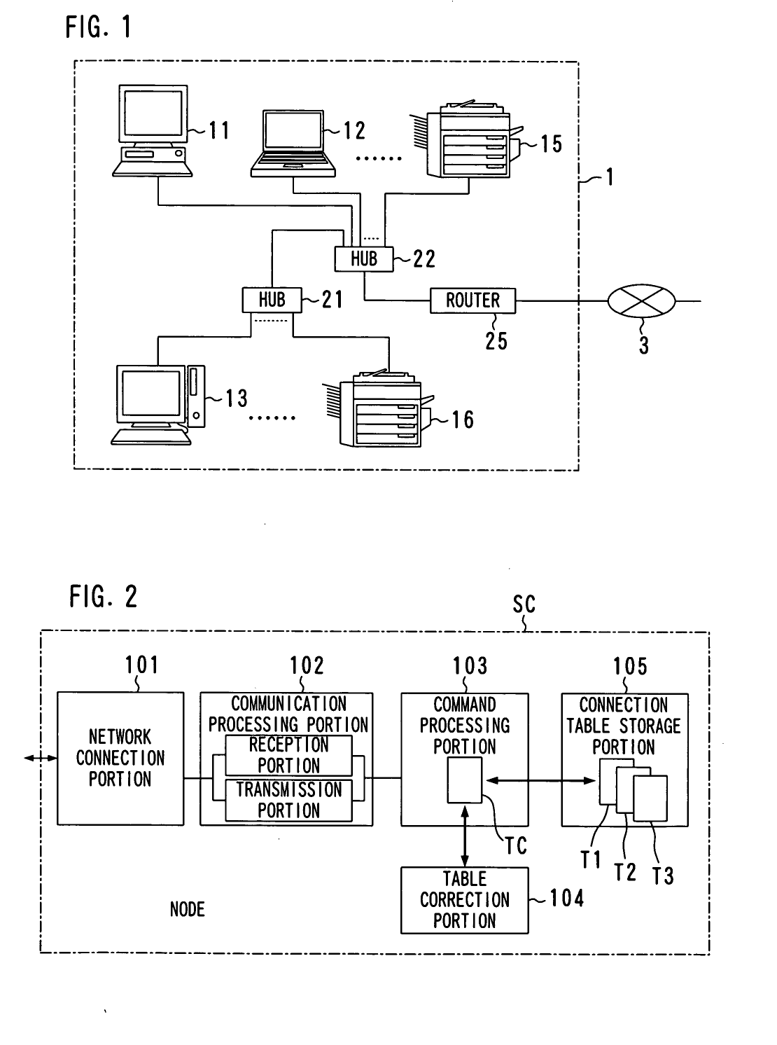

FIG. 1 is a diagram showing an example of a network configuration according to the present invention.

The network 1 is a LAN (Local Area Network) including plural personal computers 11, 12 and 13, plural multifunction devices 15 and 16, switching hubs 21 and 22, and a router 25. The network 1 can be used as, for example, a file sharing system in companies or organizations similar thereto.

The personal computers 11, 12 and 13, and the multifunction devices 15 and 16 are connected to one another by a twisted-pair cable for intercommunication via the cascaded switching hubs 21 and 22. The router 25 is linked to a wide area network 3. Note that the multifunction devices 15 and 16 are OA equipment used as a copy machine, a scanner, a printer, a facsimile machine and an image memory, and are also linked to a public line (not shown) for facsimile communication.

In the network 1, each of the personal computers 11, 12 and 13 and the multifunction devices 15 and 16 functions as a terminal that operates as a server and a client, i.e., functions as a node.

### FIRST EMBODIMENT

FIG. 2 is a diagram showing a functional configuration of the main section of a node in a first embodiment. The node SC includes a network connection portion 101, a communication processing portion 102, a command processing portion 103, a table correction portion 104 and a connection table storage portion 105.

The network connection portion 101 physically connects the communication processing portion 102 to a transmission path made up of the twisted-pair cable. The communication processing portion 102 communicates with other nodes in accordance with a predetermined protocol. The communication processing portion 102 performs filtering on received information to deliver a command to be processed to the command processing portion 103.

The command processing portion 103 responds to commands issued from an application program included in the node and commands issued from other nodes. In particular, when a table switching command is received from another node, the command processing portion 103 becomes a connection control portion unique to the present invention. The connection control portion, as described later, changes contents of a connection management table TC indicating the other end of the logical connection at the present time.

The table correction portion 104 serially and partly modifies the connection management table TC based on a communication status and the past communication records. For instance, a node that shut down is deleted from the connection management table TC. In the case where access is frequently received from a node that is not included in the connection management table TC, the node is added to the connection management table TC.

The connection table storage portion 105 stores plural connection tables T1, T2 and T3 each of which indicates the other end of a logical connection corresponding to each of plural types of logical networks determined in advance.

Of the five functional elements, each of the network connection portion 101 and the communication processing portion 102 includes hardware having a network card and a communication program. Each of the command processing portion 103 and the table correction portion 104 includes hardware having a processor executing an application program and a work memory, and a control program. The connection table storage portion 105 includes hardware or a nonvolatile memory as a substitute therefor.

With the node SC having the configuration described above, the connection management table TC is present in the work memory included in the command processing portion 103 and is referred to in communication with another node SC. For example, when a file search is performed that inquires of the network 1 as to whether a desired file is present, the command processing portion 103 informs the communication processing portion 102 of the other end of the logical connection specified in the connection management table TC. Responding to this, the communication processing portion 102 transmits a file search command to a node SC as the other end of the logical connection thus informed. The transmission destination is limited based on the connection management table TC, leading to the reduction in the traffic.

The connection management table TC that is used in this way is loaded from the connection table storage portion 105 at the time of setup when the power is applied to the node SC. Stated differently, the connection management table TC is a single one selected from among the connection tables T1, T2 and T3 stored in the connection table storage portion 105. As a general rule, a connection table that was selected at the previous time is loaded as the connection management table TC. After the loading operation, in the case where the table correction portion 104 modifies the connection management table TC, at the time of shutting down the node SC or switching logical connections according to the present invention, the connection table storage portion 105 is overwritten, so that the connection table loaded the last time is replaced with the modified connection management table TC.

When receiving a table switching command from another node SC, the command processing portion 103 loads the connection table designated by the command to use the same as the connection management table TC. In other words, the command processing portion 103 switches contents of the connection management table TC to contents of the connection table thus designated.

As described above, the node SC has a function of storing the plural connection tables T1, T2 and T3 and selectively using one of the connection tables T1, T2 and T3 as a connection management table TC for communication. This function achieves the instantaneous change of the entire logical connection configuration of the network 1.

Hereinafter, the change of the logical connection configuration is described in more detail.

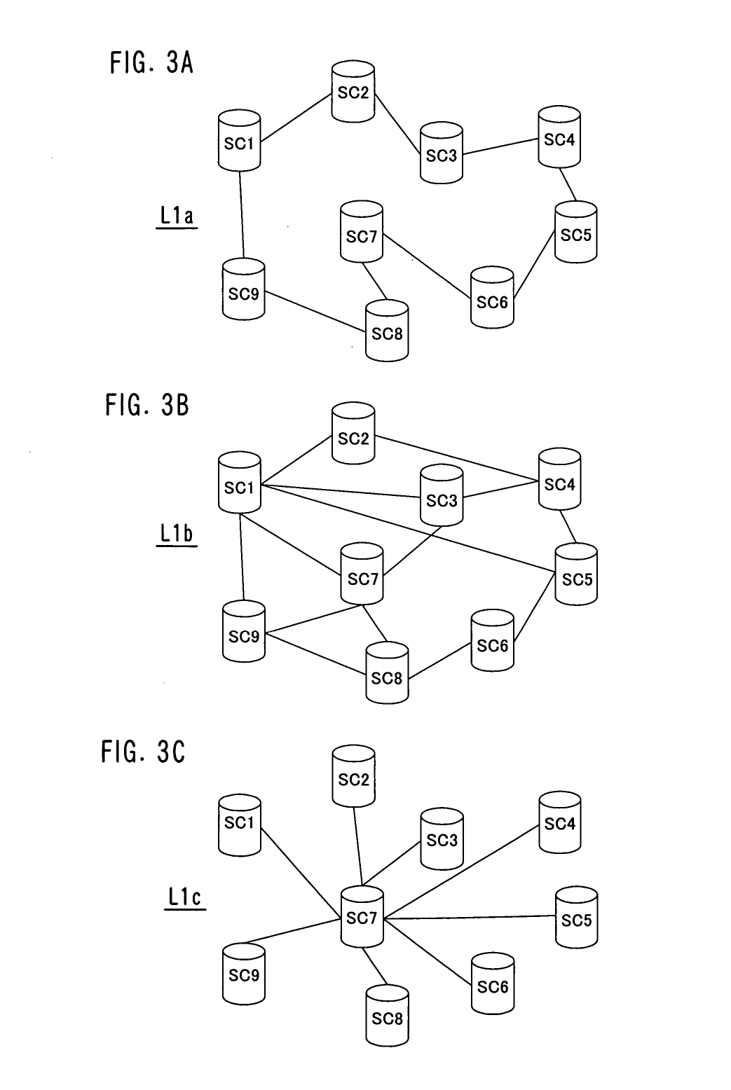

FIGS. 3A-3C show plural logical networks. The straight lines in the drawings show logical links. Here, logical connections of nine nodes SC1-SC9 are assumed for the convenience of drawing. The number of nodes, however, is not limited to nine.

A logical network L1a shown in FIG. 3A is a ring type. For example, the node SC1 communicates with the node SC2 and the node SC9, and the node SC2 communicates with the node SC1 and the node SC3. The ring type is suitable to convey information to all the nodes SC1-SC9 with the least traffic.

A logical network L1b shown in FIG. 3B is a mesh type. For instance, the node SC1 communicates with the node SC2, the node SC3, the node SC5, the node SC7 and the node SC9. The node SC2 communicates with the node SC1 and the node SC4. The mesh type is suitable for the case where each of the nodes SC1-SC9 communicates with particular nodes of the nodes SC1-SC9 frequently, as in the case of normal offices.

A logical network L1c shown in FIG. 3C is a star type. Each of the eight nodes SC1-SC6, SC8 and SC9 communicates with one node SC7. The node SC7 communicates with the other eight nodes SC1-SC6, SC8 and SC9. The star type is suitable to concurrently transmit information from a particular node to other nodes, and for the case where a particular node gathers information from other nodes. The logical network L1c is useful, for example, for the emergency case where central control is necessary, such as disaster information or evacuation guidance.

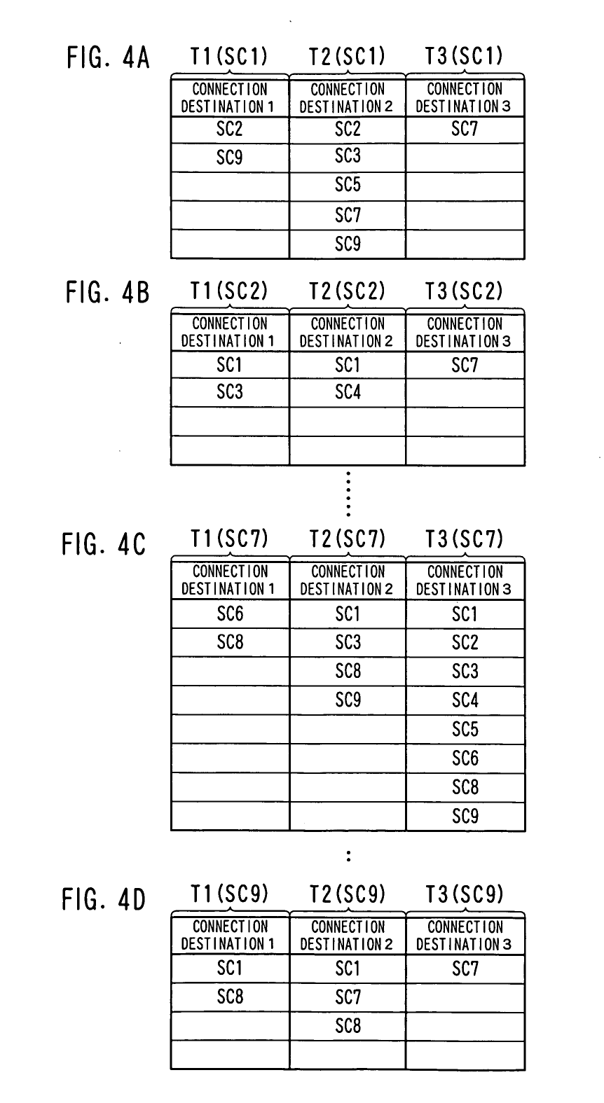

FIGS. 4A-4D show examples of contents of connection tables respectively stored in plural nodes.

The connection table contents are different among the nodes. FIGS. 4A-4D show table contents for four nodes as representative examples. FIGS. 4A, 4B, 4C and 4D show table contents for the node SC1, the node SC2, the node SC7 and the node SC9, respectively. The characters in parentheses in the drawings show the corresponding nodes.

The connection tables T1(SC1), T1(SC2), T1(SC7) and T1(SC9) correspond to the logical network L1a shown in FIG. 3A. The connection tables T2(SC1), T2(SC2), T2(SC7) and T2(SC9) correspond to the logical network L1b shown in FIG. 3B. The connection tables T3(SC1), T3(SC2), T3(SC7) and T3(SC9) correspond to the logical network L1c shown in FIG. 3C.

The following is a description of the operation of the command processing portion 103 of the node SC1 when the logical network L1a shown in FIG. 3A is switched to the logical network L1b shown in FIG. 3B. The node SC2 shall issue a table switching command.

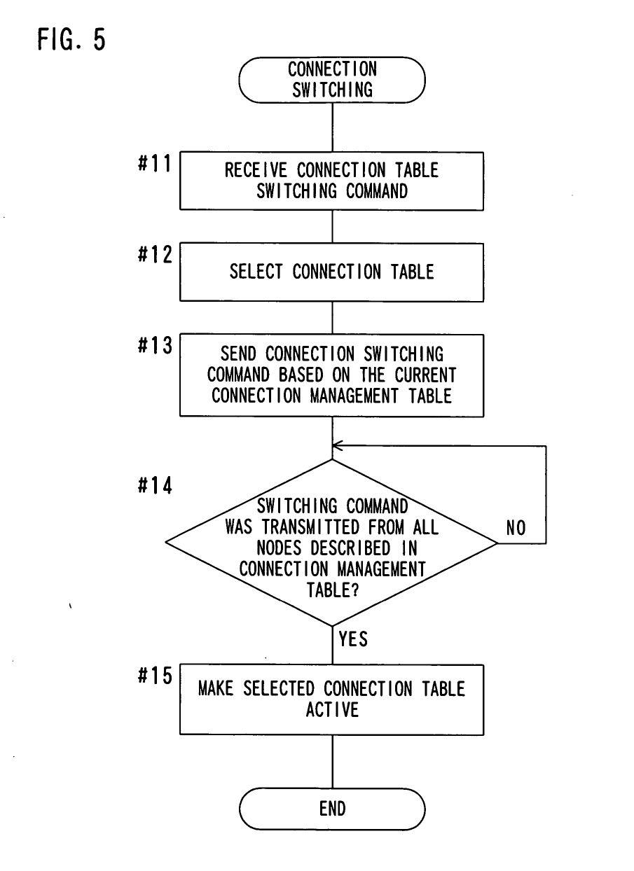

FIG. 5 is a flowchart of processing of switching connections executed by the command processing portion according to the first embodiment.

The command processing portion 103 of the node SC1 receives a connection table switching command issued from the node SC2 (#11). The connection table switching command includes designation of a connection table to which the command processing portion 103 switches (here, the connection table T2).

In response to the connection table switching command, first, the command processing portion 103 selects the connection table T2 designated by the command from among the three tables stored in the connection table storage portion 105 (#12). Then, with reference to the connection table T1 that is active at the present moment, i.e., the connection management table TC, the command processing portion 103 transmits the connection table switching command to each of the nodes described in the connection management table TC, i.e., the node SC2 and the node SC9 in this example (#13). On this occasion, the transmission to the node SC2 is a reply.

Since the same processing is performed in the node SC9, the node SC9 transmits the connection table switching command to each of the node SC1 and the node SC8. At this time, the node SC1 is in a command reception waiting state and waits for the connection table switching command issued from the nodes described in the connection management table TC.

The command processing portion 103 confirms whether or not the connection table switching command is transmitted from each of the nodes described in the connection management table TC (#14). After the confirmation, the command processing portion 103 activates the selected connection table T2 (#15). In other words, the command processing portion 103 replaces the contents of the connection management table TC with the contents of the connection table T2.

All the nodes SC1-SC9 perform the same processing, so that the contents of the connection management table TC included in each of the nodes SC1-SC9 are changed almost at the same time. Thereby, the logical connection configuration of the network 1 is switched substantially immediately.

### SECOND EMBODIMENT

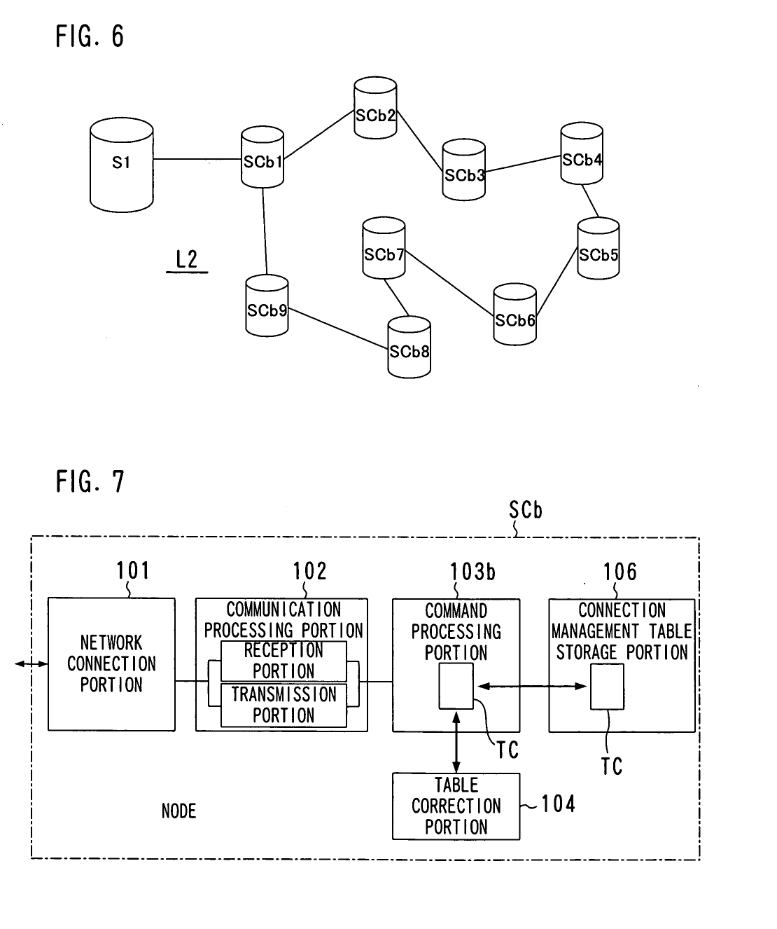

FIG. 6 shows another example of a logical network.

The illustrated logical network L2 includes nine nodes SCb1-SCb9 and one connection table distribution server S1. The logical network L2 corresponds to the combination of the logical network L1a shown in FIG. 3A and the connection table distribution server S1.

In the first embodiment described above, each of the nodes SC1-SC9 stores the connection tables T1, T2 and T3. In contrast, in the second embodiment, only the connection table distribution server S1 stores the connection tables T1, T2 and T3, and the connection table distribution server S1 transmits one necessary connection table along with a connection table switching command.

The functional configuration of the connection table distribution server S1 is basically the same as the configuration of the node SC described with reference to FIG. 2. The configuration of each of the nodes SCb1-SCb9 is as described below.

FIG. 7 is a diagram showing a functional configuration of the main section of a node in the second embodiment. In FIG. 7, structural elements having the same functions as those in FIG. 2 are given the same reference numerals/symbols as the structural elements in FIG. 2. Descriptions of such structural elements are omitted.

A node SCb shown in FIG. 7 includes the network connection portion 101, the communication processing portion 102, a command processing portion 103b, the table correction portion 104 and a connection management table storage portion 106.

The command processing portion 103b responds to commands issued by an application program included in the node and commands issued by other nodes. In particular, when receiving a table switching command, the command processing portion 103b becomes a connection control portion that changes contents of a connection management table TC to contents of a connection table distributed along with the table switching command.

The connection management table storage portion 106 holds the connection management table TC in the state where the node is shut down.

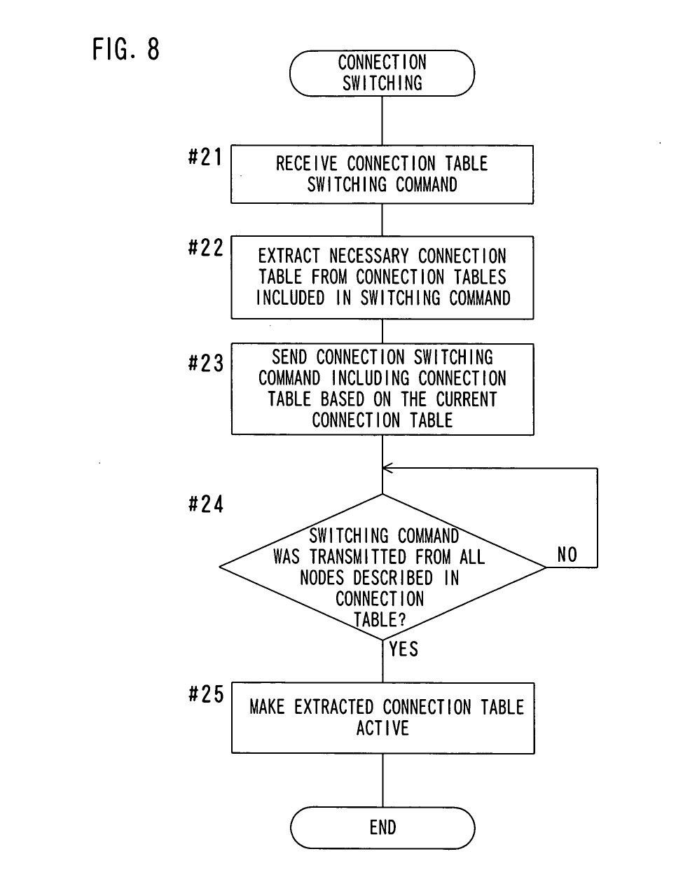

FIG. 8 is a flowchart of processing of switching connections executed by the command processing portion according to the second embodiment.

The command processing portion 103b of the node SCb receives a connection table switching command issued by the connection table distribution server S1 or another node SCb (#21). The connection table switching command includes connection tables to be used by the respective nodes SCb.

In response to the connection table switching command, first, the command processing portion 103b extracts a connection table that the node SCb should use per se from a group of the connection tables included in the connection table switching command (#22). Then, with reference to the connection table that is active at the present moment, i.e., the connection management table TC, the command processing portion 103b transmits the connection table switching command including the received connection table group as-is to each of the nodes described in the connection management table TC (#23).

The command processing portion 103b confirms whether or not the connection table switching command is transmitted from each of the nodes described in the connection management table TC (#24). After the confirmation, the command processing portion 103b activates the extracted connection table (#25). In other words, the command processing portion 103b replaces the contents of the connection management table TC with the contents of the distributed connection table.

As in the case of the first embodiment, also in the second embodiment, the logical connection configuration of the network 1 can be switched substantially immediately. According to the second embodiment, it is unnecessary for the plural nodes SCb to store plural connection tables in advance. It is preferable to make the connection table distribution sever S1 store the connection tables. Compared to the first embodiment, the second embodiment has an operational advantage that choices of logical networks can be easily changed or diversified.

According to the embodiments described above, a logical connection over the entire physical network can be changed instantaneously, which enables the proper use of the network temporally. In the case of an intranet, for example, the proper use of a network includes the following: 1. The network is used for ordinary applications, e.g., for sharing input/output equipment such as a printer or a facsimile machine, for sharing files, and for exchanging electronic mails during office hours. 2. The network is used for large computations that involve cooperation of many computers out of office hours. A configuration is possible in which when a business involving mass printing occurs in a certain department, the department can use many printers preferentially for other departments. A department in charge of multifunction devices maintenance can change a logical connection temporarily for facilitating the central control of the multifunction devices. In the case of a LAN of a research institute, logical networks can be switched in various ways to investigate the characteristics of the respective logical networks.

In the embodiments described above, the size of the network 1 (the number of nodes), the configuration and the application thereof are arbitrary. The network can be a network established in one building or a wide area network by which cities or towns geographically far away from one another are connected via a dedicated line or a public line. In addition to an intranet, the present invention can also apply to, for example, a non-profit network including computers owned by people living in a certain area.

The number of connection tables T1, T2 and T3 that are stored in the nodes SC1-SC9 or in the connection table distribution server S1 is not limited to three and is preferable to be two or more. The contents of the connection tables T1, T2 and T3, i.e., choices of a switchable logical network can be selected appropriately depending on the application of the network 1.

A reply to a connection table switching command is not essential and may be omitted. More specifically, in response to reception of a connection table switching command, it is possible to transmit the connection table switching command only to the other end of the logical connection except the transmission source and to switch the contents of the connection management table TC immediately after the transmission. It is also possible to incorporate delivery source information into a command so that a node that received the command sends a reply not to the direct transmission source but to the delivery source.

The connection table switching command may designate a switching time. In the case of operating the network 1, it may be determined whether a delivery source of a connection table switching command is arbitrary or limited to a particular node.

A configuration is possible in which plural nodes transmit connection table switching commands concurrently at a preset time. This configuration is effective in expediting the spread of commands, especially in large networks.

The present invention contributes to the improvement in usability of P2P networks.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A logical connection method in a network in which plural terminals are connected in a manner to communicate with one another, the method comprising:
letting each of the terminals store a connection management table and plural connection tables, the connection management table indicating other end of a logical connection at present, and each of the connection tables indicating other end of a logical connection corresponding to each of various types of logical networks that are determined in advance;
transmitting a table switching command that designates any of the connection tables from at least one of the terminals to the terminal that is the other end of the logical connection indicated in the connection management table stored in the terminal;
in response to reception of the table switching command, transmitting the received table switching command from each of the terminals to the terminal that is the other end of the logical connection indicated in the connection management table; and
letting each of the terminals switch contents of the connection management table to contents of the connection table designated by the received table switching command.

2. The logical connection method according to claim 1, wherein the terminal includes a table correction portion for modifying the connection management table based on a communication status.

3. The logical connection method according to claim 2, wherein the table correction portion deletes a particular terminal of the terminals from the logical network.

4. The logical connection method according to claim 2, wherein the table correction portion adds a particular terminal of the terminals to the logical network.

5. A logical connection method in a network in which plural terminals are connected in a manner to communicate with one another, the method comprising:
letting each of the terminals store a connection management table indicating other end of a logical connection at present;
letting at least one of the terminals store plural connection tables each of which indicates other end of a logical connection corresponding to each of various types of logical networks that are determined in advance;
transmitting a table switching command including any one of the connection tables from the terminal storing the connection tables to the terminal that is the other end of the logical connection indicated in the connection management table stored in the terminal storing the connection tables;
in response to reception of the table switching command, transmitting the received table switching command from at least the terminal other than the terminal storing the connection tables to the terminal that is the other end of the logical connection indicated in the connection management table; and
letting at least the terminal other than the terminal storing the connection tables switch contents of the connection management table to contents of the connection table included in the received table switching command.

6. The logical connection method according to claim 5, wherein the terminal includes a table correction portion for modifying the connection table based on a communication status.

7. The logical connection method according to claim 6, wherein the table correction portion deletes a particular terminal of the terminals from the logical network.

8. The logical connection method according to claim 6, wherein the table correction portion adds a particular terminal of the terminals to the logical network.

9. The logical connection method according to claim 5, wherein the number of the terminals storing the plural connection tables is one and the terminal storing the plural connection tables functions as a connection table distribution server.

10. A network in which plural terminals are connected in a manner to communicate with one another,
each of the terminals including
a connection management table indicating other end of a logical connection at present,
a communication portion for communicating with the terminal that is the other end of the logical connection indicated in the connection management table,
plural connection tables each of which indicates other end of a logical connection corresponding to each of various types of logical networks that are determined in advance, and
a connection control portion for switching, in response to receiving a table switching command by the communication portion, contents of the connection management table to contents of the connection table designated by the table switching command,
wherein the communication portion transmits, in response to receiving the table switching command, the received table switching command to the terminal that is the other end of the logical connection indicated in the connection management table.

11. A network in which plural terminals are connected in a manner to communicate with one another,
each of the terminals including
a connection management table indicating other end of a logical connection at present, and
a communication portion for communicating with the terminal that is the other end of the logical connection indicated in the connection management table, and
at least one of the terminals including plural connection tables each of which indicates other end of a logical connection corresponding to each of various types of logical networks that are determined in advance,
wherein the terminal including the connection tables transmits a table switching command including any one of the connection tables to the terminal that is the other end of the logical connection indicated in the connection management table, and
at least the terminal other than the terminal including the connection tables, in response to reception of the table switching command, transmits the received table switching command to the terminal that is the other end of the logical connection indicated in the connection management table, and switches contents of the connection management table to contents of the connection table included in the received table switching command.

12. An information processor capable of connecting to a network, comprising:
a connection management table indicating other end of a logical connection at present;
a communication portion for communicating with the terminal that is the other end of the logical connection indicated in the connection management table;
plural connection tables each of which indicates other end of a logical connection corresponding to each of various types of logical networks that are determined in advance; and
a connection control portion for switching, in response to receiving a table switching command by the communication portion, contents of the connection management table to contents of the connection table designated by the table switching command,
wherein the communication portion transmits, in response to receiving the table switching command, the received table switching command to the terminal that is the other end of the logical connection indicated in the connection management table.

13. An information processor capable of connecting to a network, comprising:
a connection management table indicating other end of a logical connection at present;
a communication portion for communicating with the terminal that is the other end of the logical connection indicated in the connection management table; and
a connection control portion for switching, in response to receiving, by the communication portion, a table switching command including any one of plural connection tables each of which indicates other end of a logical connection corresponding to each of various types of logical networks that are determined in advance, contents of the connection management table to contents of the connection table included in the table switching command,
wherein the communication portion transmits, in response to receiving the table switching command, the received table switching command to the terminal that is the other end of the logical connection indicated in the connection management table.
